(19) United States
(12) Patent Application Publication
(10) Pub. No.: US 2013/0091021 A1
(43) Pub. Date: Apr. 11, 2013

(54) METHOD AND SYSTEM FOR MANAGING MULTI-THREADED CONVERSATIONS

(71) Applicants: Anton Maslov, Moscow (RU); Marina Kiseleva, Moscow (RU); Dmitry Mihaylovkiy, Herzliya Pituach (IL); Andrey Arbuzov, Moscow (RU); Denis Kamenkovich, Mevasseret Zion (IL)

(72) Inventors: Anton Maslov, Moscow (RU); Evgeny Sokolov, Moscow (RU); Marina Kiseleva, Moscow (RU)

(73) Assignees: Anton Maslov, Moscow (RU); Marina Kiseleva, Moscow (RU); Denis Kamenkovich, Mevasseret Zion (IL); Andrey Arbuzov, Moscow (RU); Dmitry Mihaylovkiy, Herzliya Pituach (IL)

(21) Appl. No.: 13/645,566

(22) Filed: Oct. 5, 2012

Related U.S. Application Data
(60) Provisional application No. 61/544,045, filed on Oct. 6, 2011.

(51) Int. Cl. G06Q 30/02

(52) U.S. Cl. 705/14.69; 705/14.73

(57) ABSTRACT

Method and system for managing multi-threaded conversations to provide relevant posts to a user. Conversation fragments that relate to or exactly match a user interest are identified wherein each includes a set of branches of the conversation that connect to one another or are separated from one another by a distance below a threshold and each branch is a set of all posts about a common, preceding post and the common, preceding post. Identified fragments are ranked to form a list of fragments. Advertisers form individual conversation threads including a widget that transfers or redirects a user to a website associated with the advertiser such that fragments of advertiser-formed threads are identified. When fragments from the list of ranked fragments are presented to the user, execution of the widget in causes transfer or redirection of the user to the website.

### CROSS REFERENCE TO RELATED APPLICATIONS

The present application claims priority under 35 USC 119 of U.S. Provisional Patent Application Ser. No. 61/544,045 filed Oct. 6, 2011, the entire disclosure of which is incorporated herein by reference.

### FIELD OF THE INVENTION

The present invention relates to a method and system for managing multi-threaded conversations with a view toward enabling presentation to a user of parts or fragments of one or more such conversations that are particularly interesting to the user based on input of their interest, and more particularly to presenting such conversation fragments to the user with the ability for advertisers to transfer or redirect users to their website by forming advertiser threads, fragments of which are presented to the users.

### BACKGROUND OF THE INVENTION

At the present time, several forms of multi-user communications involving the Internet, or other communications networks, exist including chatrooms and forums. Chatrooms are the most free, unstructured form of communication because they are not moderated and are thus thematically varied. Among other reasons, the number of participants in a chatroom is virtually unlimited. Usually, individuals can post messages, or posts, in a chatroom and the messages are public and arranged chronologically. Due to the nature of chatrooms, typically they do not allow an individual to comment on the messages. As such, a multi-threaded conversation, i.e., a series of messages including some messages that are responsive to preceding messages, is not formed.

One problem with chatrooms is that the free, unstructured form of chatrooms makes the implementation of context-based communication complex, and does not enable a dialogue between two or more users, often referred to as multi-user conferencing. Another problem is that chatrooms generate thematically determined communication. In practice, the first problem, i.e., communication among several users simultaneously, is partially solved by the nature of the chatroom, and the second problem may be solved by filtering and/or categorization of the flow of messages.

Another form of multi-user communications is an Internet forum, or message board. The organizational structure of the conversations is often referred to as a thread, that is “a set of messages grouped visually in a hierarchy by topic” (see, e.g., http://en.wikipedia.org/wiki/Conversation_threading). A single conversation, in which each message is replied to by a single message, is simply called a “thread” or a “single-threaded discussion”. By contrast, a message that gives rise to a plurality of responsive messages, which in turn may each give rise to one or more responsive messages, is called a “fully threaded discussion” or a “multi-threaded conversation”.

Contemporary versions of forums are typically rigidly structured. A conversation, as a rule, should have a specific thematic character. The theme of the conversation is fixed at the time the conversation is created and it is determined in the first post. “Thematic purity” is achieved by “manual filtration” by one or more moderators. Messages that are not related to the theme are removed by a moderator, possibly being transferred into another thread, and the authors of these messages may be sent a link to the corresponding thread to which the message has been transferred.

Problems with forums include the necessity that each post may belong only to the first thread, although it may be of interest, i.e., useful, meaningful, valuable, interesting for the conversation, in different threads of the forum. Such messages may be “invisible”, which will lead to the loss of potentially valuable, meaningful, and useful information. Further, conversations with closely related themes lead to the appearance of similar threads with duplicate posts and a large number of cross-references. Furthermore, several themes could be discussed at the same time in different threads and the user has to communicate simultaneously in different threads, switching between different windows of these threads.

Thus, the essence of the problems with forums is that the structure of multi-threaded conversations reflects the momentary interest of the “theme initiator” and the spontaneous replies of the users. This structure is too rigid and static. It is identical for all users, although from the point of view of each specific user, it is not ideal.

A number of common problems exist with chatrooms and forums, including an interface that is not user-friendly. Several themes might be discussed at the same time in different threads and the user has to communicate simultaneously in different threads, switching between different windows of these threads. Moreover, with a large number of participants, the number of messages may reach hundreds, or even thousands. For effective navigation and participation, the user must have tools for annotating the conversations. Despite the fact that both chatrooms and forums are tools for multi-user communication, tools for multi-user behavior are not sufficiently developed in most chatrooms and forums.

An additional problem is that the features of the conversations are implemented on specialized communication sites, but the content is discussed on specialized content sites. As such, means of communication are needed that are distributed on content sites, allowing discussion of content at the place where it is located and easy relocation from one site to another.

It would therefore be desirable to optimize multi-user communications to present only posts or messages of interest in such communications to a user.

Prior art related to multi-user communications and messaging techniques of possible relevance to the present invention includes U.S. Pat. Nos. 6,484,196 (Maurille) entitled “Internet messaging system and method for use in computer networks”; 6,792,448 (Smith) entitled “Threaded text discussion system”; 7,383,307 (Kirkland et al.) entitled Instant messaging windowing for topic threads; 7,480,696 (Kirkland et al.) entitled “Instant messaging priority filtering based on content and hierarchical schemes”; 7,769,144 (Yao et al.) entitled “Method and system for generating and presenting conversation threads having email, voicemail and chat messages”; and 7,933,957 (Daniell) entitled “Tracking email and instant messaging (IM) thread history”; and U.S. Pat. Appln. Publ. Nos.: 20070180040 (Etgen et al.) entitled “System and method for managing an instant messaging conversation”; 20090070294 (Chijiiwa) entitled “Social Networking Site Including Conversation Thread Viewing Functionality”; and 20090319619 (Affronti) entitled “Automatic Conversation Techniques” all of which are incorporated by reference herein.

### SUMMARY OF THE INVENTION

A method and system for managing multi-threaded conversations in accordance with the invention overcomes disadvantages of chatrooms and forums, including those discussed above, and may be implemented to enable a user to communicate in any context in which they are interested. Further, the method and system may be implemented to enable a user to select one or more of their interests in which case, a processing unit accepts the user interest(s) and based thereon, determines separate parts of one or more multi-threaded conversations to present to the user, e.g., on a display associated with the user interface at which the user provided their interest(s). If the interests of the user change, the selected parts of the conversations change. More specifically, the method and system determine separate fragments of conversations to present based on the interests of users, which determination factors in the relevance of fragments of conversations, and enables the annotation of fragments of conversations based on fragments of messages.

In the method and system, advertisers form individual threads of the multi-threaded conversation including a widget that transfers or redirects a user to a website associated with the advertiser such that fragments of advertiser-formed threads are identified by the processing unit. As such, when fragments from the list of ranked fragments are presented to the user, execution of the widget in one of the presented fragments causes transfer or redirection of the user to the website.

### BRIEF DESCRIPTION OF THE DRAWINGS

The invention may best be understood by reference to the following detailed description of and illustrative embodiment when read in conjunction with the accompanying drawings, wherein:

FIG. 1 is a flow cart showing steps of a basic method in accordance with the invention;

FIG. 2 is a flow chart showing a method in which branches are considered when seeking fragments of a multi-threaded conversation for presentation to a user;

FIG. 3 is an illustration including outlines of branches of the tree and indicates which posts have been identified as being relevant in consideration of the users search interests;

FIG. 4 is an illustration of a tree-type structure of branches derived from the tree shown in FIG. 3;

FIG. 5 is a flow chart showing an exemplifying method in which relevance of fragments is determined in accordance with the invention;

FIG. 6 is a flow chart showing an exemplifying method in which fragments are summarized in a step of the method shown in FIG. 5;

FIG. 7 is a flow chart showing an exemplifying method in which the determined relevance of fragments is used to create a virtual temporary community of users with similar interests;

FIG. 8 shows schematically structure of a system for managing multi-threaded conversations in accordance with the invention and that is capable of performing the method for managing multi-threaded conversations in accordance with the invention;

FIG. 9 is a diagram explaining an attraction factor function used in the invention;

FIGS. 10A and 10B show one manner for mapping a tree structure of a conversation;

FIGS. 11A-11E show various depictions of a tree structure of conversations;

FIGS. 12A-12E show additional depictions of a tree structure of conversations; and

FIG. 13 is a flow chart showing a business model referred to as conversations associated with external resources or AdDiscussion that is based on a method in accordance with the invention.

### DETAILED DESCRIPTION OF THE INVENTION

As an introduction to the invention, a method for managing one or more multi-threaded conversations will be described with reference to flow charts that outline important steps of the invention. These steps are not exclusive and other steps may also be included in the method in accordance with the invention. The steps in each flow chart can be implemented by appropriate software or programming in a manner that is known to those skilled in the art.

For the following descriptions, definitions of some recurring terms are as follows:

As used herein, a “post” will generally mean an entry in a blog, internet forum or chat. Often, a post is provided in response to an opening statement.

As used herein, a “thread” will generally mean a tree structure of a single conversation originating with a single statement or post and to which a plurality of individuals provide posts.

As used herein, a “fragment” will generally mean a restricted-by-size subtree with a density of the distribution of relevant posts above a threshold.

As used herein, a “tree” or “subtree” will generally mean a widely-used data structure that emulates a hierarchical tree structure with a set of linked nodes, each node including one or more posts.

As used herein, a “weight function” will generally means a mathematical device used when performing a sum, integral, or average in order to give some elements more “weight” or influence on the result than other elements in the same set.

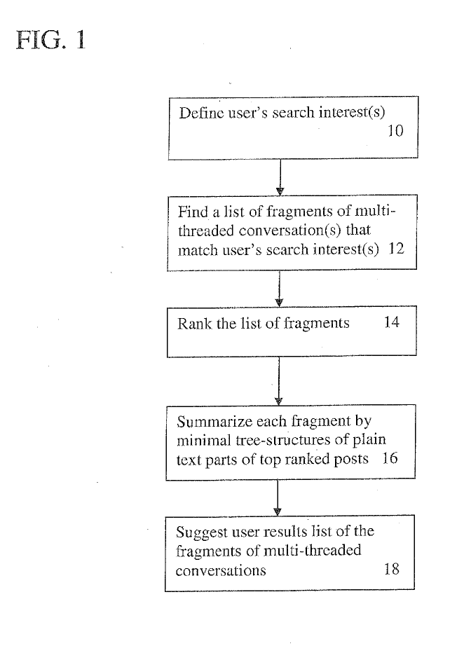

FIG. 1 provides an overview of the basic steps of one embodiment of a method for managing one or more multi-threaded conversations in accordance with the invention. One of the objects of the method is to present to an interested party, fragments of one or more multi-threaded conversations that are most pertinent to the user, based on correspondence between the user's defined search interests and the fragments of the conversation(s). As such, fragment retrieval achieved by the inventive method includes the task of returning subtrees of conversation structure that provide the user with access to a set of posts of one or more conversations that are relevant to their search interests. Fragment retrieval thereby provides the user with both the content and context of conversations in a single result.

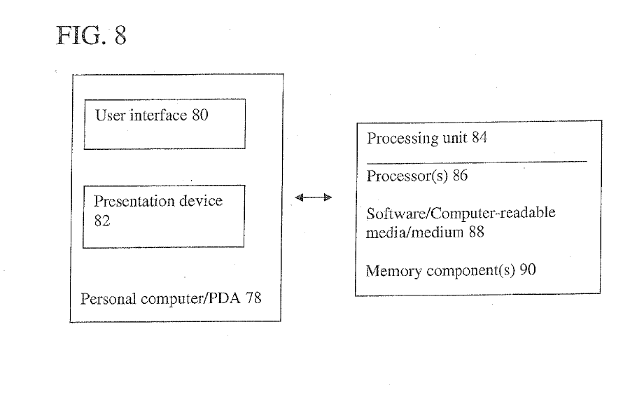

The first step 10 is to obtain the user's search interests. The user will be considered the person interested in obtaining fragments of multi-threaded conversations. Often, the user will be the individual using a user interface to interact with a processing unit that is coordinating the method. Using the user interface coupled to the processing unit, the user would define their search interests in any of a number of different ways. For example, the user could type in their search interests using a keyboard as the user interface or speak their search interests using a microphone (a free form entry), or writing posts, or removing, identifying, pasting, designating or subscribing to individual fragments of the conversation(s) or specify search interests from a list of possible search interests displayed on a display associated with the processing unit or user interface. The user's search interests may be stored, after definition by the user, in a data storage or memory unit associated with the processing unit. The structure of a system in accordance with the invention for managing multi-threaded conversations is schematically shown in FIG. 8, discussed below.

The next step 12 in the method is for the processing unit to find or identify a list of fragments of multi-threaded conversations that match the user's search interest(s). This matching step is performed by one or more processors associated with the processing unit using any number of possible matching algorithms. When the interests are the same (or at least substantially similar), the processor would form a list of the identified fragments. In one embodiment, the processing unit would be configured to determine fragments that relate to the user's search interest(s), with this relationship being either an exact match, e.g., the fragment includes the same exact term indicated as by the user as being their interest (both the user's search interest and fragment includes the same subject such as “bichon frise dogs”), or a close but not exact match, e.g., the fragment does not include the same word indicated as by the user as being their interest but a related word (the user's search interest is “bichon fries dogs” while the fragment includes only the “dogs”). This close match is this a partial match and the processing unit can be configured to first seek fragments with the exact search term used as the search interest and then if none are found, seek close matches.

In step 14, the processing unit would rank the fragments in the list to form a ranked list of fragments. This ranking may be performed by the same or a different processor of the processing unit that performs the fragment locating and identification step.

In step 16, the Fragment (F) are summarized by minimal tree structures of plain text-parts of top ranked posts.

In step 18, the list of fragments, after having been ranked and summarized, is provided to the user, for example, displayed on a display associated with the user interface at which the user defined their search interests. It is possible that the entire ranked list of fragments is not provided to the user at the same time due the memory or visualization constraints. Thus, there may be a threshold number of fragments applied and the fragments from the top of the ranked list to the threshold number provided to the user. This step of providing or presenting the list of ranked fragments to the user is not essential and the invention may function to rank the list of fragments, with the subsequent presentation being an optional, yet preferred, stage.

The processing unit is typically configured to monitor the user's data or information input to detect changes in the user's interests. To this end, the user can be provided with means to access a management system that will receive and process their user interests (described below) and when a change in the user's interests is detected, steps 12, 14, 16 and 18 would be (re)performed to be responsive to the user's change in their interests.

In a more specific embodiment of the above method, the concept of a “branch” (Br) will be introduced and constitutes a set of all “child” comments on a singular post (P), plus the post (P) itself, child comments being comments subsequent to the singular post (P).

For this embodiment of the invention, a fragment (F) will be considered as a set of Branches (Br) containing relevant posts that have been connected with each other or with a distance between them below a threshold. This threshold may vary based on the number of fragments found and may be set by a manager of the method and system in accordance with the invention based on experience.

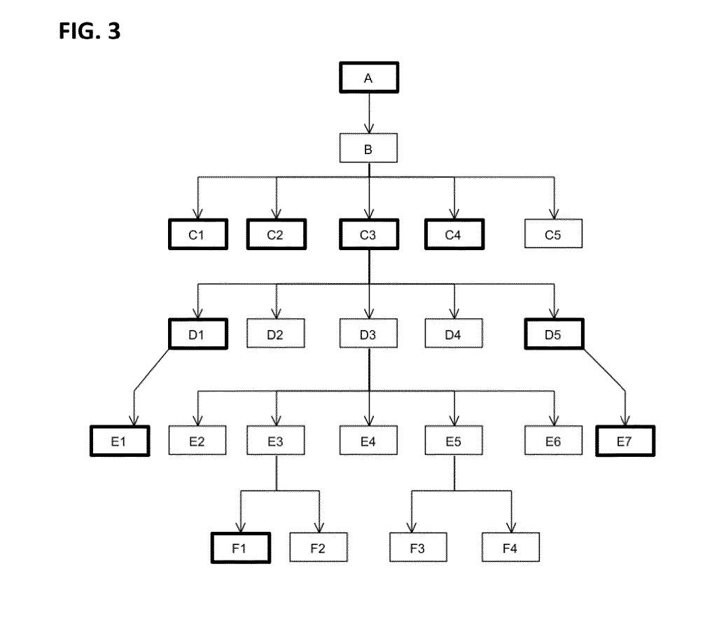

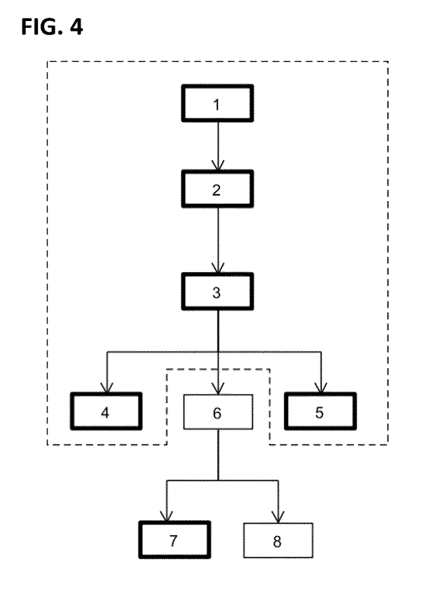

As for an application of this embodiment of the method, FIG. 3 shows the tree-type post structure of conversation thread, including a single, common post A and a plurality of additional posts. FIG. 3 includes a marking indicating which posts have been deemed to be relevant based on the user's search interests. These posts are A, C1-C4, D1, D5, E1, E7 and F1. FIG. 4 shows a tree-type structure of branches, with each branch being indicated as a rectangle. The formation of these branches being novel herein. Using the definition provided above, each branch includes a post itself, any of its siblings, and the immediate parent post. Branch 1 therefore includes only posts A and B. Branch 2 includes post B and posts C1-C5. Branch 3 includes post C3 and posts D1-D5. Branch 4 includes post D1 and post E1. Branch 5 includes post D5 and post E7. Branch 6 includes post D3 and posts E2-E6. Branch 7 includes post E3 and posts F1 and F2. Branch 8 includes post E5 and posts F3 and F4.

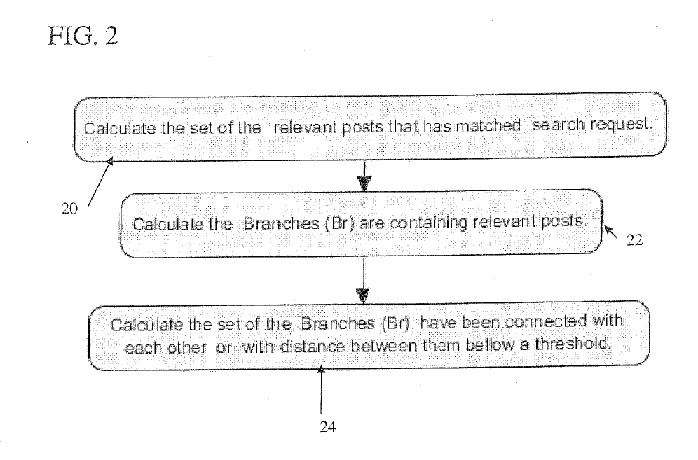

FIG. 2 shows basic steps in a method for determining a Fragment of the Multi Threaded Conversation. The first step 20 is to calculate, identify or otherwise determine a set of the relevant posts that has matched the search request (a derivative of step 12 in FIG. 1). The next step 22 is to calculate, identify or otherwise determine the Branches (Br) that contain the posts determined to be relevant in step 20. Thus, if post C3 is determined to be relevant in step 20, branches 2 and 3 would be identified in step 22. FIG. 4 shows which branches, of branches 1-8, include one or more of these relevant posts, branches 1, 2, 3, 4, 5 and 7

The next step 24 is to calculate, identify or otherwise determine a set of the branches (Br) identified in step 22 that are connected with each other or have a distance between them below a predetermined or predefined threshold. This step is a derivative of step 14 in FIG. 1. That is, all of the branches identified in step 22 are not presented to the user. Rather, an analysis is conducted as to whether any of the branches are connected to one another, and if so, these connected branches are provided to the user. Similarly, depending on the threshold, branches that are separated from one another, but by less than a threshold distance, are also presented to the user. It is therefore sought to avoid presenting the user with very remotely connected branches because the threads including these branches are highly likely to be different to the extent they would not contain information of interest to the user based on the user's defined search interests (step 10). FIG. 4 also shows an outline of the set of branches that have been determined to be connected to one another, branches 1-5 and this set is provided to the user. Branch 7 is not connected to any of the other branches 1-5 and, in this case, is not below the threshold distance between branches containing relevant posts and therefore is not provided to the user.

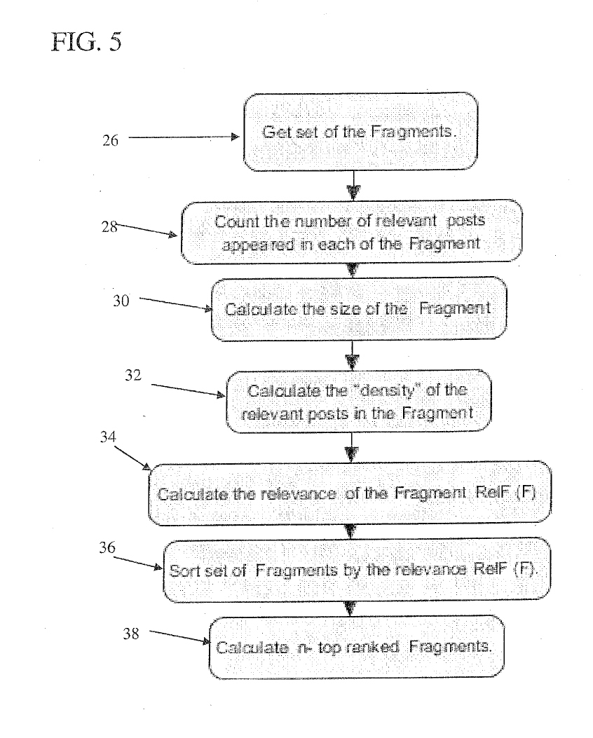

Ranking of the list of identified fragments, step 14, may be performed in various different ways, including using currently existing post-relevance ranking techniques. According to one embodiment of the invention however, ranking is performed according to the steps shown in FIG. 5. In this ranking algorithm for evaluating the relevance and ranking fragments of a multi-threaded conversation, also referred to herein as a structural relevance measure, the relevance of a Fragment, RelF (F), is based on the relevance of the post(s) contained in the fragment (F). Assuming that for a given search query, each post (P) has a relevance value Rel(P), whereby:

for a fully relevant post Rel(P)=1;

for a fully irrelevant post, Rel(P)=0; and

for all other cases, 0< Rel(P)<1.

For a Fragment (F), RelF (F) is defined in terms of the relevance Rel(P) of its posts. Several formulations are possible, for example, including but not limited to, a weight function of the size of the Fragment, its depth, rank distribution of relevant posts in the Fragment, and other parameters relating to the post individually or the post relative to other posts.

The simplest formulation is the average relevance of the posts (“density” of the relevant posts in the Fragment (F) multiplied by sum of their relevance). Use of the average relevance prevents larger Fragments from getting higher scores. This is reflected in the following equation:

$$RelF ( F ) = \frac{{\sum }_{P ∈ F} Rel ( P )}{\vert F \vert}$$

where |F| is the number of posts in the Fragment (F), and Rel(P) is the calculated relevance value of the post (P).

An individual post may be considered as a “singleton”, i.e., a tree consisting of one element. So Fragment retrieval may return the individual post as a separate rank Rel(P). Each Fragment (F) can be summarized (annotated) by a minimal tree structures of plain text-parts of top ranked posts (see step 16 in FIG. 1).

In practice, the user can observe limited level of depth structure of each Fragment at once. Fragment retrieval can be formulated as retrieval of the set of maximum weighted fragments restricted by their depth.

This is implemented in a method using a processing unit including one or more processors, in which the first step 26 is to get or obtain a set of fragments, each containing at least one relevant post. The number of relevant posts appearing in each Fragment (F) is then calculated, step 28, and the size of the fragment is also calculated, step 30. The “density” of the relevant posts in the Fragment (F) is determined, e.g., calculated, step 32, and then the relevance of the Fragment, RelF (F), is calculated or otherwise determined, step 34. The set of fragments is then sorted by the calculated relevance RelF (F), step 36, and the n-top ranked fragments are identified or calculated, step 38. N is a variable number, or threshold, which may be set by the user or the manager of the method. Thereafter, the ranked list of n-top ranked Fragments (F) is presented to the user.

The method for ranking fragments described above may be applied in a variety of different ways in a social networking arrangement. In one way, users with similar interests, i.e., users that have defined their search interests which are the same as other users' defined search interests, are grouped together into temporary virtual communities. This aggregation or consolidation of users with similar interests, or behavior (that can be defined as or removing or subscribing to individual fragments of the conversation(s)), into temporary virtual communities is an outgrowth of the method for ranking fragments (additional and more detailed discussion about formation of a temporary virtual community or micro community is set forth below).

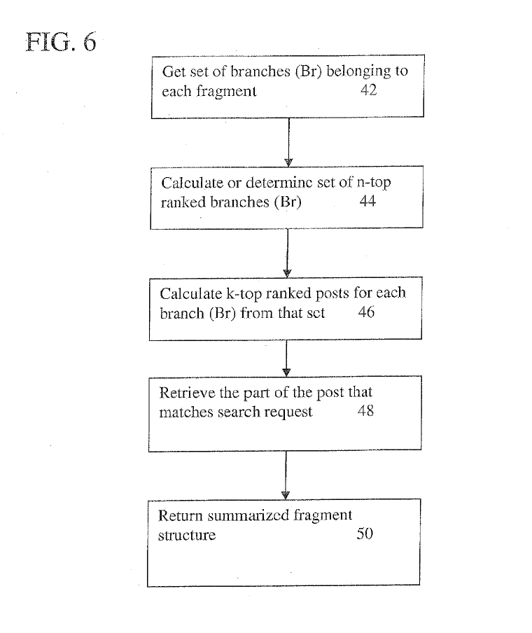

Step 16 in FIG. 1, the summarizing of the fragments by minimal tree structures of plain text-parts of top ranked posts, is further detailed in FIG. 6, which is an exemplifying method to perform this summarization using a processing unit including one or more processors, such as processing unit 84 described herein. As shown in FIG. 6, the first step 42 in the summarization of the fragments is to obtain the set of the Branches (Br) belonging to each Fragment. Then, the set of n-top ranked Branches (Br) in each fragment is calculated, step 44, and the k-top ranked posts for each Branch (Br) from that set is calculated, identified or otherwise determined, step 46. K is a variable number, or threshold, which may be set by the user or the manager of the method. At step 48, the part of the post that match the user's defined search request (step 10) are retrieved. Finally, a summarized Fragment structure is obtained, step 50

As shown in FIG. 8, the basic system would include a personal computer/PDA or the like 78 of each user, each of which would include at least one user interface 80 that enables a user to input at least one interest, a presentation device 82 that provides to the user relevant posts based on the input user interest(s) and a processing unit 84 coupled to the user interface(s) and the presentation device. This coupling may be a wired connected or a wireless connection in whatever manner the personal computer/PDA 78 connects to the Internet. The processing unit 84 includes one or more processors 86, software embodied on computer readable media 88 and most likely one or more memory components 90, and is configured to perform functions of the methods described above. For example, the processing unit 86 is configured to identify fragments of one or more of the multi-threaded conversations that match each input user interest, rank the identified fragments of the multi-threaded conversation(s) to form a list of fragments ranked according to relevance, and present a number of fragments at a top of the list of ranked fragments via the presentation device 82.

The computer program or programs resident on computer-readable media 88 at the processing unit 84 are designed to perform the identification, ranking and presentation functions, i.e., directing commands to the presentation device 82 to cause the presentation or display of the identified fragments with relevant posts of one or more multi-threaded conversations based on the user's interest(s). The processing unit 84 may identify the fragments of the multi-threaded conversations in a variety of different ways. In one way, the processing unit 84, or software 88 thereat working in conjunction with the processor(s) 86, determines a set of relevant posts that match the user interest(s), determines a set of branches that contain the determined set of relevant posts, and determines from the set of branches that contain the determined set of relevant posts, a set of branches that connect to one another or are separated from one another by a distance below a threshold.

Further, the ranking program at the processing unit 84 can rank the identified fragments of the multi-threaded conversation(s) in a variety of different ways. In one way, the ranking program determines a density of the relevant posts in each fragment based on a number of relevant posts in the fragment and a size of the fragment, determines a relevance of each fragment based on the determined density of the fragment, and determines a number of the fragments at a top of a list of fragments ranked pursuant to the determined relevance.

The ranking program may additionally summarize each fragment at the top of the list of fragments ranked pursuant to the relevance. This summarization may be achieved in a variety of different ways. In one way, the processing unit summarizes each fragment by determining a number of branches in each fragment at a top of a list of branches ranked according to relevance, determining a number of posts, for each branch at the top of the list of branches ranked according to relevance, that are at a top of list of posts ranked according to relevance and obtaining part of each of these posts, to thereby obtain the summarization of each fragment.

As mentioned above, the fragments of several multi-threaded conversations identified by method or system in accordance with the invention may be displayed, as one form of presentation, to the user. In one embodiment, this display takes the form of a single vertical column, i.e., a mono-column user interface, in which parts of different conversations are displayed. This mono-column interface combines in a common display screen, which may be all or part of a display screen of the personal computer/PDA 78, fragments of conversations from different threads of communication and even different types of conversations. For example, in this single vertical column display, there may be fragments from one or more chatrooms, one or more message boards, one or more internet forums, etc.

Such a vertical column display of the screen of the personal computer/PDA 78, i.e., the presentation device 82, may appear as follows (with the fragments ordered based on relevance):

Fragment 1 from conversation on chatroom 1
Fragment 2 from conversation on chatroom 3
Fragment 4 from conversation on chatroom 4
Fragment 6 from conversation on message board 3

Alternatively, posts from the different Fragments (different branches of Fragments) can follow each other in interleaved order. This creates the opportunity to catch most interesting posts from different part of the conversation fragment. Posts may be organized (sorted, filtered) in different ways: chronologically, by post relevance, by hierarchical structure. The fact that the post belongs to the Fragment (different branches of Fragments) can be coded by a color, an icon, etc.

Post from Fragment 4
Post from Fragment 2
Post from Fragment 1
Post from Fragment 3
Post from Fragment 4
Post from Fragment 1

By arranging fragments of different conversations in the single vertical column, it appears to the user that the fragments are part of a single conversation (this being an appearance only because the fragments are actually part of four different conversations in the display above). Accordingly, it can be seen that there is an illusion presented to the user that the fragments are parts of one conversation, even though they are actually parts of four different conversations and encompass two different types of conversations, e.g., chatrooms and message boards. Each fragment appears as a separate element in the mono-column interface and has a separate set of controls and status, as in the following depiction:

Fragment 1 from conversation on chatroom 1
Controls/Status
Fragment 2 from conversation on chatroom 3
Controls/Status
Fragment 4 from conversation on chatroom 4
Controls/Status
Fragment 6 from conversation on message board 3
Controls/Status

The controls for each fragment relate to actions of the users and examples of such actions are described elsewhere herein, e.g., “Follow” or “Follow conversation”, “Close” or “Delete”, “Recommend” and “Invite into”. Generally, a respective set of controls and status designated areas are assigned to each fragment, whether below each fragment as in the depiction above, it otherwise proximate or associated with the fragment. The set of controls and status may also be located in the mono-column or alongside it. The controls enable the user to follow results of the search, i.e., identified fragments, that are valuable to the user, one an individual basis, as well as remove search results that are not important to the user, thereby freeing up space for potentially more interesting identified fragments.

In the mono-column display, different display formats of the fragments are envisioned. In a compact display, key and/or new fragments or messages are shown in an automatic scrolling scheme (creeping line). In an expanded display, a frame showing the active fragments displaces remaining frames from the vertical column, excluding the immediately preceding and immediately following frames. After an initial ranking and presentation on the single column display, the ranking is periodically re-performed and the ranking results refreshed, which re-ranking and refreshing are enabled by suitable configuration of the processing unit in a manner known to those skilled in the art in view of the disclosure herein.

The processor responds to the user interface 80 to effect user-desired controls, including, for example, enabling the user to modify (reject or remove) the results of the search for fragments in the same column in which the fragments are displayed, without requiring the identified fragments to be discarded and thereby requiring another search based on the desired modification.

Moreover, the processing unit 84 may be programmed by software to continually update or refresh the search, based on the most recently entered user interest(s) and display any newly identified fragments in the vertical column.

Various user actions and display variants are available in the invention. Continual or continuous refreshing of the search results prompts the user to protect, i.e., “follow up” and monitor, the results that are important to him or her (which feature may be implemented as a “Follow Conversation” routine), and to remove results that are unimportant (which feature may be implemented as a “Close Conversation” routine), freeing up space for potentially more interesting and important fragments.

It is preferred in the single vertical column to present each fragment as a separate element of the interface, with a separate set of controls and status. In a compact display (which may be the default status of the processor in its control of the display of the personal computer/PDA 78), important and/or new messages in the fragments are shown in accordance with an automatic scrolling scheme (which appears like a “creeping line” type of display). Alternatively, in an expanded display of the fragments, a frame showing the active fragment displaces the remaining frames from the vertical column, excluding the preceding and the following frame. If a user activates the branch, then the parent fragment frame will display content of that branch. This allows users to move to hierarchically connected parts of conversation, which connected parts are not necessarily the results of search.

The tree structure of the fragment can be visualized by a space-filling radial (or rectangular) diagram (modifications of polar area diagram, sunburst, radial tree map). Such a radial diagram shows how child conversation branches sprout off of the parent branches. The top branch is the center section, and each ring sector away from the center is one level down into the conversation tree. Each ring is divided into sections representing each branch belonging to the parent sector. An angular size and height of each section depicts different attributes relative to sibling brunches. There is the list of the attributes of the fragment of conversation that can be mapped into the space-filling radial diagram: number of posts (all post, newest posts, have been read, etc.), number of users (authors of posts, users are browsing this fragment of conversation . . . ), sum of posts relevance, etc. Each attribute can be mapped as a single one or in combination with other.

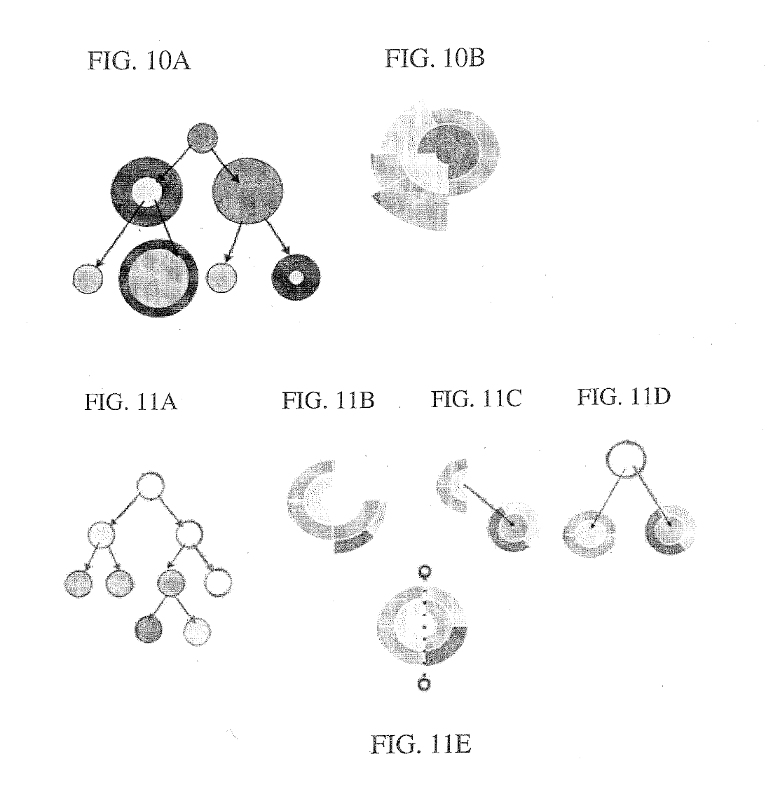

An example of mapping a tree structure of a conversation, that shown in FIG. 10A, into a space-filling radial diagram is shown in FIG. 10B. Each circle depicts one branch of a conversation. The radius of the circle radius depicts one attribute, for example, the total number of posts. A second attribute (total relevance, for example) can be depicted as contour thickness on FIG. 10A or section height in FIG. 10B.

Referring now to FIGS. 11A-11e, a diagram can describe a complex structure that consists of a set of non-directly linked fragments of conversations. White, empty sections depict non-relevant branches of conversation in FIGS. 11A-11E. The decision of putting different fragments into the same diagram depends on the distances between these fragments. FIG. 11A shows a tree structure of branches connected to one another which can be depicted in different ways. For example, FIG. 11B shows a corresponding complex diagram of the relevant fragments, FIG. 11C shows hierarchically linked fragments, FIG. 11D shows independent fragments, and FIG. 11E omits the empty sections and the gap between sub-fragments is depicted by a dashed line.

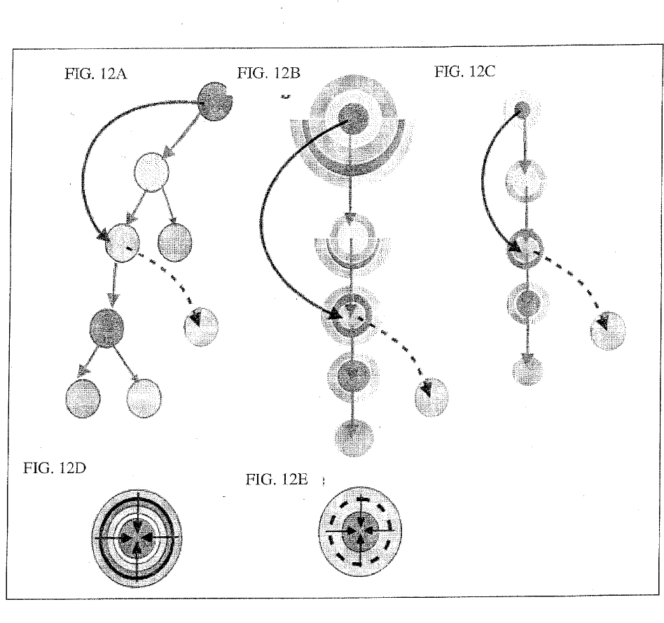

Referring to FIGS. 12A-12E, navigation history can be thought as a graph that consists of branches that have been visited by a user. Nodes are linked by edges that describe the order of browsing. In FIG. 12A, navigation paths are coded by colored lines with arrows. There are three navigation paths: sequential transition from a node to its child (coded by red color); a jump to node that are not neighbor one (coded by black color); and a jump to a different independent conversation branch (coded by black dashed line). FIGS. 12B and 12C depict navigation paths as a sequence of diagrams. Each radial diagram corresponds to a fragment structure to which transition was executed. As such, navigation history can by coded by concentrically circles that are nested in each other as shown in FIGS. 12D and 12E.

Referring back to the formation of the temporary virtual micro community, which is a set of users who have browsed similar sets of conversation fragments during a time interval, various algorithms for this may be used. Resources associated with the shared set of fragments of discussions can be thought as shared resources for these users. Each user can be included into various “temporary virtual micro communities” with different degrees of membership. As such, each user can see (observe) shared resources associated with various temporary virtual micro communities. Ranking of a resource can depend on a degree of representation of the fragment among shared fragments and rank of the resource in relation to the fragment.

In one algorithm implemented by the processing unit, the issue is to measure the “attraction factor” for users Ui and Uj. It can be denote as function ATTR (Ui.Uj)= function ((SIM (Ui,Uj), PROX (Ui.Uj)). The “attraction factor” can be considered to be a probability of an attraction (involvement) them into a conversation as participants.

The term “similarity” for users Ui and Uj can be measured as

$$SIM ( {U}_{i} , {U}_{j} ) = SIM ( {sF}_{i} , {sF}_{j} ) = \frac{\vert {sF}_{i} ⋂ {sF}_{j} \vert}{\vert {sF}_{i} ⋃ {sF}_{j} \vert}$$

where Ui and Uj are users, sFi and sFj are their sets of features, and |A| is the size of set A. The term “similarity” for users thus constitutes a degree of coincidence of their sets of features associated with shared set of fragments. Features can describe the interests and behavior of user. User actions associated with a shared set of fragments such as posting messages, links to external or internal resources, voting and usage of shared resources, transitions to other fragments can be thought as a user behavior. In turn, a community behavior can be thought as summarized behavior of users.

The micro-community may provide various features to facilitate collaboration among participants. The community features may include mechanisms of evaluation shared resources, such as voting, and polls. The community features may enable placement of advertisements, establishing sponsorships to the community.

The term “social proximity” for users Ui and Uj can be thought as a measure of degree of familiarity or neighborhood and can be determined as a function of a minimal distance in the social contacts graph, existence and relative volume of correspondence between them. As such, the “social proximity” of two essentially familiar sets is a number close to one, but that for most pairs of unfamiliar ones, the “social proximity” is a number close to zero.

For example, PROX(Ui,Uj)=1/(DIST(Uᵢ, Uⱼ))² where DIST(Uᵢ, Uⱼ) is a minimal distance in the social contacts graph between users Ui and Uj, considered to be a minimal number of edges between them.

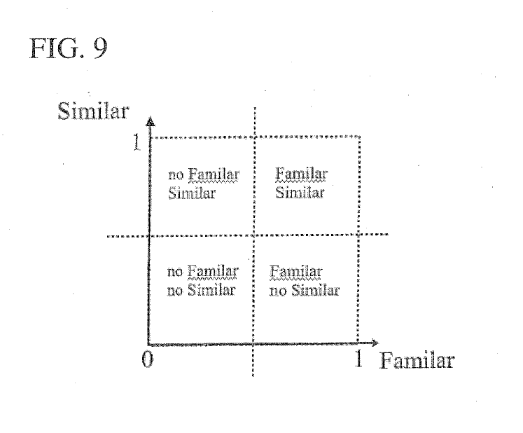

The attraction factor function can be constructed to achieve maximum (or minimum) values on quadrants specified in advance (shown in FIG. 9). By defining a maximum on the quadrant, the system is forced to convergence (to aggregate) users with given relationship type. The aggregation of “similar” users acts as a positive feedback, while the aggregation of “unsimilar” acts as a negative one. An aggregation of “noSimilar” can produce network-wide uniformity (homogeneity), while aggregation of “Similar” tends to drive the network toward smaller clusters of like-minded individuals.

From a user perspective, a positive feedback tends to maintain the membership of community, while allow to change fragments of conversation, providing the opportunity to “follow community”. Negative feedback forces a user to travel through communities. It provides an opportunity for each user to know different sets of shared resources. Each user can choose the preferable model of feedback using their user interface, and which preferences are stored in the processing unit 84 or an associated memory component 90 in an appropriate form.

In one algorithm, The aggregation of “similar” users acts the issue is to measure “similarity” between a pair of users. The term “similarity” for users Ui and Uj can be measured as

$$SIM ( {U}_{i} , {U}_{j} ) = SIM ( {sF}_{i} , {sF}_{j} ) = \frac{\vert {sF}_{i} ⋂ {sF}_{j} \vert}{\vert {sF}_{i} ⋃ {sF}_{j} \vert}$$

where Ui and Uj are users, sFi and sFj are their sets of conversation fragments, and |A| is the size of set A. The term “similarity” for users thus constitutes a degree of coincidence of sets: the number of common elements divided by the total number of elements in the two subsets, so that the similarity of two essentially-equivalent sets is a number close to one, but that for most pairs of dissimilar ones, the similarity is a number close to zero.

Aggregation is the association of users with similar interests appearing on the same fragments of conversations.

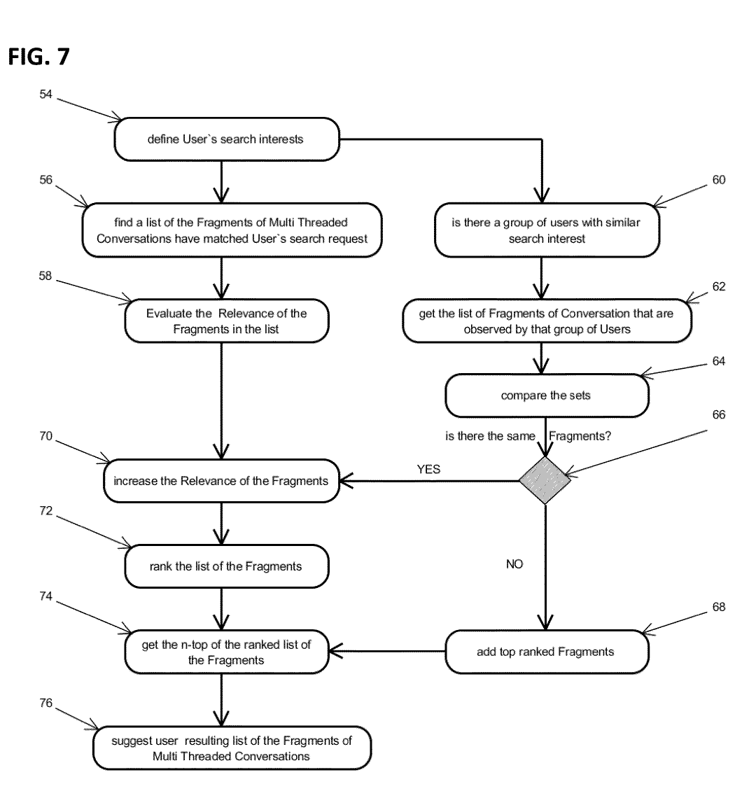

FIG. 7 shows how aggregation occurs in accordance with the invention. At step 54, the user defines their search interests (see step 10 in FIG. 1 described above). A list of fragments of multi-threaded conversation that match the user's search interests is identified at step 56 (see step 12 in FIG. 1 described above), and the relevance of the identified fragments in the list is evaluated at step 58. This relevance evaluation may be based on relevance of the fragments in the manner described above. After the user defines their search interest(s), a determination is made at 60 whether there is a group of users with similar search interests, or at least one other user with a similar search interest. If so, a list of fragments of conversation that are observed by any user with a similar search interest is obtained at step 62, and this list is compared at step 64 to the list of identified fragments from step 58. At step 66, a determination is made as to whether there are common fragments in both lists, and if not, at step 68, the top ranked fragments are added to the list of identified fragments from step 58.

On the other hand, if there are common fragments, at step 70, the relevance of the common fragments is increased in the list of identified fragments from step 58. The list of fragments is then ranked at step 72, and a list of the n-top ranked fragments is compiled at step 74. This list is presented to the user at step 76 (see step 16 in FIG. 1 described above).

In summary, “temporary virtual micro communities” can be formed by modifying the method of ranking fragments of conversation by taking into account an attraction factor as defined above. Moreover, in a side or auxiliary panel alongside the single vertical column in which the conversation fragments are displayed on the presentation device 82, similar sets of fragments of conversation to users with a high level of the attraction factor can be displayed.

More generally, a derivative method for communal behavior based on the multi-threaded conversation management methods described above entails identifying a group of users with closely related interests according to the degree of similarity of conditions for selecting (searching) conversations. Thus, users that search for conversation and select some fragments for review may be grouped together based on the search and/or the selection. Although grouping users together based on common interests may be performed in a number of different ways, in accordance with the invention, it is performed in a novel way in that the grouping is performed according to the degree of similarity of fragments of multi-threaded conversation associated with the users, in the multi-threaded conversation structure. Additionally or alternatively, the users may be grouped together according to the similarity of the actions in response to the search results (behavior as the realization of interests).

This latter considers the actions of the users with identified fragments of the multi-threaded conversation identified to each user based on their defined user interest(s). Options for user actions, some of which are described above, include “Follow”, “Close” or “Delete”, “Recommend” and “Invite into”, while actions for posts contained in the conversation fragments include “commenting”, “For” or “against”, “Spam”, “Unprintable” and “Recommend”, while actions with links (to external resources and to fragments of multi-threaded conversation” include “Voting”, “Recommend” and “Transfer”. Accordingly, if presented with the same list of conversation fragments, several users decide to delete a fragment, these users may be grouped together. Similarly, if presented with the same list of conversation fragments, several users decide to follow the same post in a fragment, these users may be grouped together, and if presented with the same list of conversation fragments with an external link, several users decide to recommend the fragment, these users may be grouped together.

Aggregation or consolidation of the users with similar interests (in consideration of the user-defined interest causing identification of fragments) and/or behavior (in consideration of responses to the identified fragments or parts thereof) is performed by the processing unit 84 with a view toward forming the “temporary virtual communities”. Aggregation consists of users with similar interests appearing on the same threads of conversations. Users with similar interests and behavior are shown nearby sets of fragments of the multi-threaded conversation (according to any of the fragment relevance ranking techniques disclosed herein).

In another embodiment, developing the concept of temporary virtual micro communities further, each community has its own associated temporary virtual pages, analogous to a user's page). These community pages show some or all of the fragments or parts thereof that caused the creation of the specific community, for example, common fragments of multi-threaded conversation, common resources (links), links to external resources, and links to fragments of multi-threaded conversation. The community pages can also show tools for communal use of resources, joint evaluation (voting) materials, and joint transfer. These capabilities may be provided by appropriate icons or other user-activated areas on the display of the community page.

Moreover, part of the content of these community pages may be displayed in the form of a separate frame in the user interface

Even further, once the community pages are formed and managed by the processing unit 84, it is possible for users of the community or others to follow the temporary virtual communities. This may be achieved by enabling each user to receive notifications of changes in the status of these communities, most likely by an agreement or consent of the user to participate in this following activity.

When searching for the relevance of a conversation, the relevance of searching general web content can be defined as a set of N-top relevant search results. The set would be the same for all searchers regardless of their number. Thus, even ten thousand searchers would get the same N-top relevant search results for the same input. For the foregoing disclosure of this allocation method, a conversation is generally considered to be content generated by users. Thus, a “searcher of conversation” can become a “participant of conversation”, i.e., if the searching user decides to post a comment about something found as a result of the search. As more people get the same discussion in their search results, the greater the number of potential participants that can be involved in that conversation.

An issue arises regarding the maximum number of participants of a conversation. As known to those skilled in this art, there is an optimal number of participants of online conversation that ensures a high level of interaction with sufficient feedback ability. This number depends of a nature of a conversation and can be from tens to hundreds of users. Exceeding the threshold number of conversation participants can cause to a decay of the discussion.

Regulation of the size of the temporary virtual micro communities is desirable and can be achieved in conjunction with the aggregation technique. As such, the number of users who will be shown identical search results (i.e., identical fragments of multi-threaded conversations) is limited to a maximum number.

Another application of the identification of a set of conversation ranked according to relevance based on a user interest(s) is as a means of communication distributed over content sites. This application is designed such that communication takes place either on the base site of the service (the service that provides the identification of conversation fragments), or using a widget on partner sites. The method for managing multi-threaded conversation may be implemented at a processing unit 84 or comparable server accessible by the personal computer/PDAs 78 of multiple users via the Internet or an intranet. The manager or organizer of the method would therefore be providing a conversation management service at a website.

When a user initially accesses this website to perform the method, the website may be designed to install one or more widgets on the personal computer/PDA 78. Installation of the widget at the personal computer/PDA 78 enables the processing unit 84 to publish links to content, which may be of interest to visitors to the website, and prompts them into conversations.

Widgets may be installed by advertisers interested in promoting the sale or use of goods or services. Referred to as “AdDiscussion threads”, such threads are strictly associated with the advertiser which installed the service widget. AdDiscussion threads, just like any other threads of conversations, are present in the results of search requests by the users. As such, any user who is subscribed to AdDiscussion may be automatically transferred (redirected) to the advertiser's site at least once in the course of the user session. In accordance with the invention, it is performed in a novel way in that each user can easily navigate from one site to another in the communication process.

An important advantage of the installation of the widgets on the personal computer/PDA 78 of each user is that each user can communicate on any site that has installed the widget.

Once a user is provided with fragments of multi-threaded conversations based on their search interests, additional services can be provided by processing unit 84. Some of these services are designed to provide revenue for an entity operating the processing unit 84, or traffic to websites of the operating entity or advertisers.

One such service is a business model involving conversations associated with external resources or AdDiscussion as mentioned above. This service provided by the processing unit 84 can be thought as an Internet advertising model used to direct traffic to websites, due to exchange or buying and selling of advertising links embedded in threads of conversations referred to as the “AdDiscussion threads”.

AdDiscussion threads, just like any other threads of conversations, take place on partner sites by using a widget, described above. The threads can contains links to content and consumer recommendations and opinions, which may be of interest to visitors to the website, and is intended to prompts the visitors into conversations, i.e., into entering posts, comments, messages and the like. AdDiscussion threads are strictly associated with the advertiser. As such, any user who wants to participate in the AdDiscussion may be automatically transferred (redirected) to the advertiser's site at least once in the course of the user session.

An exemplifying revenue model is based on a transaction fee. A publisher places AdDiscussion threads on the website. An advertiser pays for each visitor to the publisher's website that takes a defined action in response to an AdDiscussion thread. For example, a visitor might simply “view” the ad, a visitor might visit an advertiser's site, a visitor might visit an advertiser's site and take a specified action (a purchase, a form submission, and so on) linked to the advertisement. Models for determining cost per transaction can be flat-rate (the advertiser and publisher agree upon a fixed amount that will be paid for each transaction) and/or bid-based (the advertiser competes against other advertisers in an auction hosted by an advertising network or the entity operating the processing unit 84 that implements the AdDiscussion feature). AdDiscussion may offer financial incentives to publishers, for example, in the form of a percentage of revenue.

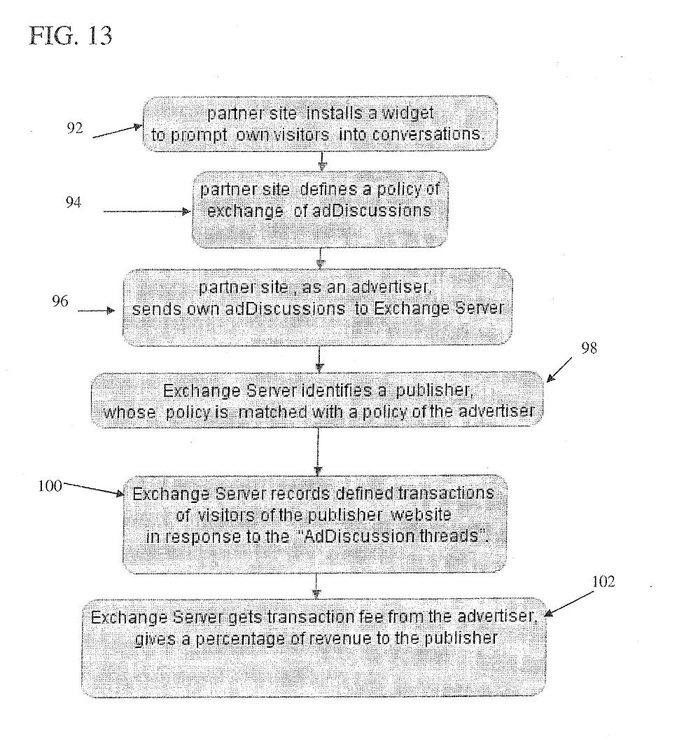

FIG. 13 shows basic steps in the business model for the AdDiscussion feature. The first step 92, is for a partner site, e.g., a site agreeing to participate in the AdDiscussion feature, to install a widget to prompt visitors to the site into conversations. The partner site also defines a policy of exchange of posts, comments, messages and the like of AdDiscussion, step 94. Importantly, the partner site, as an advertiser, sends its own AdDiscussion(s) to an exchange server, step 96. The exchange server identifies a publisher, whose policy is matched with a policy of the advertiser, step 98. The exchange server records defined transactions of visitors of the publisher website in response to the AdDiscussion threads, step 100. Then, the exchange server gets a transaction fee from the advertiser, and provides a percentage of revenue to the publisher, step 102.

For step 94, the definition of a policy of exchange of AdDiscussions can include, but is not limited to, definition of keyword phrases relevant to their target market, definition of a desirable transaction, definition of a cost per transaction, and definition of a requirements to site of opponent, i.e., a publisher or an advertiser (content, traffic, etc.).

An additional service emanating from the identified of fragments of multi-threaded conversation described above is a business model community associated with external resources, also referred to as the AdCommunity feature. This feature is a development on the business model AdDiscussion described above. AdCommunity provides a user with a series of additional privileges, services, bonuses in exchange for permanent membership. Additional privileges, services, bonuses may include access to more extensive materials, invitations to events (such as product demonstrations and test drives), discounts on services received, receiving a wider range of services, etc. Permanent membership can commit the user to receive mailings and/or other communications within the scope of the conversations service, for example, to participate in polls.

Advertising revenue can be calculated based on the number of permanent members of the community and include advertising revenue for unique visitors (not members of the community) per month.

According to research, social media sites (Facebook, Twitter, StumbleUpon, Fark.com, reddit, Digg) send only about 11% of traffic to content pages, while search engines send the largest slice of referral traffic to content, about 41%. Links from publisher sites make up about 31% of referral traffic to content pages, portal homepages account for about 17% of traffic.

At the same time, the study showed that searchers who use social media are more engaged overall and more likely to be looking for places to buy and brands to consider for product purchases. Consumers using social media are about 1.7 times more likely to search with the intention of making a list of brands or products to consider purchasing compared to the average internet user. Consumers exposed to influenced social and paid searches exhibit about 223% heavier search behavior than consumers exposed to paid searches alone. Moreover, about 50% of social-media exposed searchers search daily for product terms compared to only about 33% of non-exposed searchers In organic searches, consumers searching on brand product terms who have been exposed to a brand's social marketing campaign are about 2.4 times more likely to click on organic links leading to the advertiser's site than the average user seeing a brand's paid search advertisement alone.

These statistics are not surprising if one takes into account that in 2009, internet users worldwide trust to recommendations from people known is about 90%, to consumer opinion posted online is about 70%, to brand sponsorships is about 64%, to search engine results ads is about 41%, and to online banner ads is about 33%

In view of this data, the invention, and particularly, the AdDiscussion feature, should have a significant advantage in that its implementation will lead to an increase in traffic to partner sites. Indirectly, these expectations are confirmed by the Facebook reports:
Levi's saw a 40 times increase in referral traffic from Facebook after implementing the “Like” button in April 2010 and has maintained those levels since.
Outdoor sporting goods retailer Giantnerd.com saw a 100% increase revenue from Facebook within two weeks of adding the “Like” button.
American Eagle added the “Like” button next to every product on their site and found Facebook referred visitors spent an average of 57% more money than non-Facebook referred visitors

According to researchers, participant branded communities are 9 times more likely to revisit the site than an average client, twice more likely to be loyal than an average client, buy twice as much as the average client, and buy 5 times as much as the average client.

Several computer programs resident on computer-readable media may be used in the invention and their function and non-limiting location are mentioned above. In the context of this document, computer-readable media or medium could be any non-transitory means that can contain, store, communicate, propagate or transmit a program for use by or in connection with the method, system, apparatus or device. The computer-readable medium can be, but is not limited to (not an exhaustive list), electronic, magnetic, optical, electromagnetic, infrared, or semi-conductor propagation medium. The medium can also be (not an exhaustive list) an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The medium can also be paper or other suitable medium upon which a program is printed, as the program can be electronically captured, via for example, optical scanning of the paper or other medium, then compiled, interpreted, or otherwise processed in a suitable manner, if necessary, and then stored in a computer memory. Also, a computer program or data may be transferred to another computer-readable medium by any suitable process such as by scanning the computer-readable medium.

The basic method and system for managing a multi-threaded conversation to provide relevant posts to a user based on a user interest, described above, may be used in a variety of different ways. As mentioned above, the fragments of several multi-threaded conversations identified by method or system in accordance with the invention may be displayed, as one form of presentation, to the user in the form of a mono-column user interface, in which parts of different fragments of conversations from different threads of communication and even different types of conversation are displayed. For example, in this single vertical column display, there may be fragments from one or more chatrooms, one or more message boards, one or more internet forums, etc. However, use of a mono-column user interface is not required to practice the method.

Another use of the method and system for managing a multi-threaded conversation is for a “temporal virtual micro community”, as mentioned above, wherein the method is modified in consideration of a set of users who have browsed similar sets of conversation fragments during a time interval. Resources associated with the shared set of fragments of discussions can be thought as shared resources for these users. By modifying the method of ranking fragments of conversation based on action by the users in the temporal virtual micro community, different types of “temporal virtual micro communities” can be built, possibly providing for network-wide uniformity (homogeneity). One implementation of the method forces a user to “travel through” communities and provides user with the opportunity to know different sets of shared resources. Also, by forming smaller clusters of like-minded individuals, this embodiment of the method tends to maintain membership in the community, while allowing for changes in the fragments of conversation, thereby providing an opportunity for each user to befriend or follow the community. Again, use of the method for this community forming initiative is not the only application of the method and its disclosure should not be interpreted to limit the method in any manner whatsoever.

Furthermore, the method and system for managing a multi-threaded conversation may be designed such that communication takes place either on the base site of the service (the service that provides the identification of conversation fragments), or using a widget on partner sites. Installation of the widget enables an entity to publish links to content as they desired, which may be of interest to visitors to the website, and prompts the visitors into conversations. A more important advantage of the installation of the widgets on partner sites is that each user can communicate on any site that has installed the widget and easily navigate from one site to another in the communication process. The method therefore provides a conversation management service at a website and can be thought as conversation management service distributed over content sites.

As discussed above, in a further development of the method and system for managing a multi-threaded conversation, widgets may be installed by advertisers interested in promoting the sale or use of goods or services. Referred to as “AdDiscussion threads”, such threads are strictly associated with the advertiser which installed the service widget. AdDiscussion threads, just like any other threads of conversations, are present in the results of search requests by the users. By appropriate configuration or design of the widget, any user who participates in the AdDiscussion, or wants to participate in the AdDiscussion may be automatically transferred (redirected) to the advertiser's site at least once in the course of the user session.

In yet another development discussed above, the method and system for managing a multi-threaded conversation may be integrated into a business model referred to as a community associated with external resources (AdCommunity) which is an extension or development of the business model AdDiscussion. AdCommunity gives the user a benefit in the form of one or more additional privileges, services, and/or bonuses in exchange for permanent membership. At a minimum, each user that is a member of the virtual community receives at least one benefit not provided to users that are not members of the virtual community. The existence of the benefit(s) therefore urges the users to become permanent members of the virtual community. Different types of members may receive different benefits.

None of these uses of the method and system for managing a multi-threaded conversation is intended to limit application of the method and system. Further, the method and system may be applied and develop in different ways than those described herein and such application and development derived from the instant disclosure is considered to be part of the invention.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims.

1. A method for managing at least one multi-threaded conversation to provide relevant posts to at least one user based on at least one interest of each user, each multi-threaded conversation including an initial statement and posts about the initial statement or about a preceding post in the multi-threaded conversation, the method comprising:
identifying, using a processing unit, fragments of the at least one multi-threaded conversation that relate to the at least one user interest, each fragment comprising a first set of branches of the at least one multi-threaded conversation that connect to one another or are separated from one another by a distance below a threshold distance, each branch of the first set of branches being a set of all posts about a common, preceding post and the common, preceding post itself;
ranking, using the processing unit, the identified fragments of the at least one multi-threaded conversation to form a list of fragments; and
enabling advertisers to interact with the processing unit and form individual threads of the multi-threaded conversation including a widget that transfers or redirects a user to a website associated with the advertiser such that fragments of advertiser-formed threads are identified by the processing unit;
whereby a number of fragments from the list of ranked fragments can be presented to the user such that execution of the widget in one of the presented fragments causes transfer or redirection of the user to the website.

2. The method of claim 1, further comprising determining revenue for an operator of the processing unit, using the processing unit, based on the user's interaction with the website associated with the advertiser after transfer or redirection thereto.

3. The method of claim 1, further comprising presenting, using a presentation device, a number of fragments from the list of ranked fragments.

4. The method of claim 3, wherein the step of ranking the identified fragments comprises ranking the identified fragments pursuant to relevance and the step of presenting the fragments from the list comprises presenting a number of fragments at a top of the list of ranked fragments.

5. The method of claim 1, wherein the step of identifying the fragments of the at least one multi-threaded conversation comprises:
determining, using the processing unit, a set of relevant posts that relate to the at least one user interest;
determining, using the processing unit, a second set of branches that contain the determined set of relevant posts; and
determining, using the processing unit, from the second set of branches that contain the determined set of relevant posts, the first set of branches that connect to one another or are separated from one another by a distance below the threshold,
whereby the identified fragments include the first set of branches that connect to one another or are separated from one another by a distance below the threshold.

6. The method of claim 1, wherein the step of ranking the identified fragments of the at least one multi-threaded conversation comprises:
determining, using the processing unit, a density of the relevant posts in each fragment based on a number of relevant posts in the fragment and a size of the fragment;
determining, using the processing unit, a relevance of each fragment based on the determined density of the fragment; and
determining, using the processing unit, a number of the fragments at a top of the list of fragments ranked pursuant to the determined relevance.

7. The method of claim 1, further comprising summarizing, using the processing unit, each of the fragments at the top of the list of fragments ranked pursuant to the relevance by minimal tree structures of plain-text parts of top-ranked posts.

8. A system that manages at least one multi-threaded conversation each including an initial statement and posts about the initial statement or about a preceding post in the multi-threaded conversation, the system comprising:
at least one user interface that enables a user to input at least one interest;
a processing unit coupled to said at least one user interface and that is configured to:
identify fragments of the at least one multi-threaded conversation that relate to said at least one user interest, each fragment comprising a first set of branches of the at least one multi-threaded conversation that connect to one another or are separated from one another by a distance below a threshold, each branch in said first set being a set of all posts about a common, preceding post and the common, preceding post itself;
rank the identified fragments of the at least one multi-threaded conversation to form a list of fragments ranked pursuant to relevance; and
enable advertisers to form individual threads of the multi-threaded conversation including a widget that transfers or redirects a user to a website associated with the advertiser such that fragments of advertiser-formed threads are identified by said processing unit;
whereby a number of fragments from the list of ranked fragments can be presented to the user such that execution of the widget in one of the presented fragments causes transfer or redirection of the user to the website.

9. The system of claim 8, further comprising a presentation device coupled to said processing unit and including a display and that presents a number of fragments from the list of fragments to the user.

10. The system of claim 9, wherein said processing unit is configured to rank the identified fragments pursuant to relevance and control said presentation device to present a number of fragments at a top of the list of ranked fragments on said display.

11. The system of claim 8, wherein said processing unit is further configured to determine revenue for an operator of the processing unit, using the processing unit, based on the user's interaction with the website associated with the advertiser after transfer or redirection thereto.

12. The system of claim 8, wherein said processing unit is further configured to identify the fragments of the at least one multi-threaded conversation by:
determining a set of relevant posts that relate to said at least one user interest;
determining a second set of branches that contain the determined set of relevant posts; and
determining from the second set of branches that contain the determined set of relevant posts, the first set of branches that connect to one another or are separated from one another by the distance below the threshold,
whereby the identified fragments includes the determined, first set of branches that connect to one another or are separated from one another by the distance below the threshold.

13. The system of claim 8, wherein said processing unit is further configured to rank the identified fragments of the at least one multi-threaded conversation by:
determining a density of the relevant posts in each fragment based on a number of relevant posts in the fragment and a size of the fragment;
determining a relevance of each fragment based on the determined density of the fragment; and
determining a number of the fragments at a top of a list of fragments ranked pursuant to the determined relevance.

14. The system of claim 8, wherein said processing unit is further configured to summarize each of the fragments at the top of the list of fragments ranked pursuant to the relevance by minimal tree structures of plain-text parts of top-ranked posts.

15. A computer program embodied on computer-readable media that manages at least one multi-threaded conversation to provide relevant posts to a user based on at least one interest of the user, each multi-threaded conversation including an initial statement and posts about the initial statement or about a preceding post in the multi-threaded conversation, the computer program being configured to:
identify fragments of the at least one multi-threaded conversation that relate to the at least one user interest, each fragment comprising a first set of branches of the at least one multi-threaded conversation that connect to one another or are separated from one another by a distance below a threshold, each branch in first set being a set of all posts about a common, preceding post and the common, preceding post itself;
rank the identified fragments of the at least one multi-threaded conversation to form a list of fragments ranked pursuant to relevance; and
enable advertisers to form individual threads of the multi-threaded conversation including a widget that transfers or redirects a user to a website associated with the advertiser such that fragments of advertiser-formed threads are identified by said processing unit,
whereby a number of fragments from the list of ranked fragments can be presented to the user such that execution of the widget in one of the presented fragments causes transfer or redirection of the user to the website.

16. The computer program of claim 15, wherein the computer program is further configured to display fragments from the list of ranked fragments to the user on a display.

17. The computer program of claim 16, wherein the computer program is further configured to rank the identified fragments pursuant to relevance and display a number of fragments at a top of the list of ranked fragments on the display.

18. The computer program of claim 15, wherein the computer program is further configured to determine revenue for an operator of the processing unit based on the user's interaction with the website associated with the advertiser after transferor redirection thereto.

19. The computer program of claim 15, wherein the computer program is configured to identify the fragments of the at least one multi-threaded conversation by:
determining a set of relevant posts that match the at least one user interest;
determining a second set of branches that contain the determined set of relevant posts; and
determining from the second set of branches that contain the determined set of relevant posts, the first set of branches that connect to one another or are separated from one another by the distance below the threshold,
whereby the identified fragments includes the determined, first set of branches that connect to one another or are separated from one another by the distance below the threshold.

20. The computer program of claim 15, wherein the computer program is configured to rank the identified fragments of the at least one multi-threaded conversation by:
determining a density of the relevant posts in each fragment based on a number of relevant posts in the fragment and a size of the fragment;
determining a relevance of each fragment based on the determined density of the fragment; and
determining a number of the fragments at a top of a list of fragments ranked pursuant to the determined relevance.

21. The computer program of claim 15, wherein the computer program is further configured to summarize each of the fragments at the top of the list of fragments ranked pursuant to the relevance by minimal tree structures of plain-text parts of top-ranked posts.
